(19) United States
(12) Patent Application Publication
(10) Pub. No.: US 2003/0229542 A1
(43) Pub. Date: Dec. 11, 2003

(54) Method and system for providing a dynamically changing advertisement

(76) Inventor: Lawrence Morrisroe, Cupertino, CA (US)

Correspondence Address: James J. Decarlo Esq., Stroock & Stroock & Lavan LLP, 180 Maiden Lane, New York, NY, 10038, US

(21) Appl. No.: 10/456,742

(22) Filed: Jun. 5, 2003

Related U.S. Application Data
(60) Provisional application No. 60/386,268, filed on Jun. 5, 2002.

(51) Int. Cl. G06F 17/60

(52) U.S. Cl. 705/14

(57) ABSTRACT

A method and system for providing a dynamically changing advertisement. The system of one embodiment includes a web server, an advertisement server and an end user processor coupled to a network. The web server serves a dynamically changing advertisement, which dynamically changes based upon data. The system and method are both capable of identifying a first data and comparing it with a second data and altering the advertisement based upon the difference.

### CROSS-REFERENCE TO RELATED APPLICATIONS

This application claims the benefit of U.S. Provisional Patent Application Serial No. 60/386,268, entitled METHOD AND SYSTEM FOR PROVIDING A DYNAMICALLY CHANGING ADVERTISEMENT filed on Jun. 5, 2002, which application is hereby incorporated by reference herein.

### BACKGROUND OF THE INVENTION

1. Field of the Invention

The present invention relates generally to providing advertisements via a network, such as the Internet, and, more particularly, to advertisements whose content dynamically changes based upon different data.

2. Description of Related Art

Advertising through the Internet and the World Wide Web (web) has become very popular in recent years. As more people use the Internet on a regular basis, retailers and other advertisers have started to see the Internet as a way to reach more consumers. Moreover, Website operators have expanded the use of advertisements on their websites as they see the displaying of advertisements on their web sites as a crucial source of revenue, as well as a way to supply more services to their users.

However, recently the effectiveness of certain advertisements has been called into question. For example, banner advertisements—rectangular advertisements across the top of a web page, and skyscraper advertisements—rectangular advertisements along either side of a web page, have become so ubiquitous so as to be largely unnoticed and ignored. Indeed, due to the effort and expense in creating unique advertisements, many advertisements are reused, thus adding to the ineffectiveness of typical advertisements. Accordingly, a need exists for an improved method and system for providing advertisements that generate user interest and response.

Furthermore, because the revenue generated by an advertisement is relatively small, the cost of creating and serving an advertisement must be kept relatively small. Cost considerations include, for example, both the time and expense of creating advertisements as well as uploading, storing and updating advertisements. Accordingly, a need exists for an improved method and system for providing advertisements that generate user interest and response that are cost effective.

### SUMMARY OF THE PRESENT INVENTION

The present invention satisfies the foregoing and other needs. In certain embodiments a method and system is provided for serving an advertisement that dynamically changes with reference to data. One system according to the present invention provides dynamically changing advertisements and includes a web server, an advertisement server and an end user processor coupled to a network.

A method according to one embodiment involves retrieving a first data from an end user's computer, comparing that first data to a second data and changing content within an advertisement based upon the difference between the first and second data. In certain of such embodiments, the data represents first and second dates.

A method according to another embodiment involves retrieving data from a cookie stored on an end user's computer, comparing the first data with second data and dynamically changing an advertisement based upon the difference between the first and second data.

### BRIEF DESCRIPTION OF THE DRAWINGS

The following drawing figures, which are merely exemplary and not meant to be limiting of the scope of the invention, are a part of the present application.

FIG. 1 is a schematic illustrating the system architecture according to one embodiment of the present invention.

FIG. 2 is a schematic illustrating the content of an exemplary advertisement according to one embodiment of the present invention.

FIG. 3 is a flow chart illustrating the operation of the software program that creates an advertisement according to one embodiment of the present invention.

FIG. 4A is exemplary code for determining whether to display days or hours according to one embodiment of the present invention.

FIG. 4B is exemplary code for determining the time remaining until a specified future date according to one embodiment of the present invention.

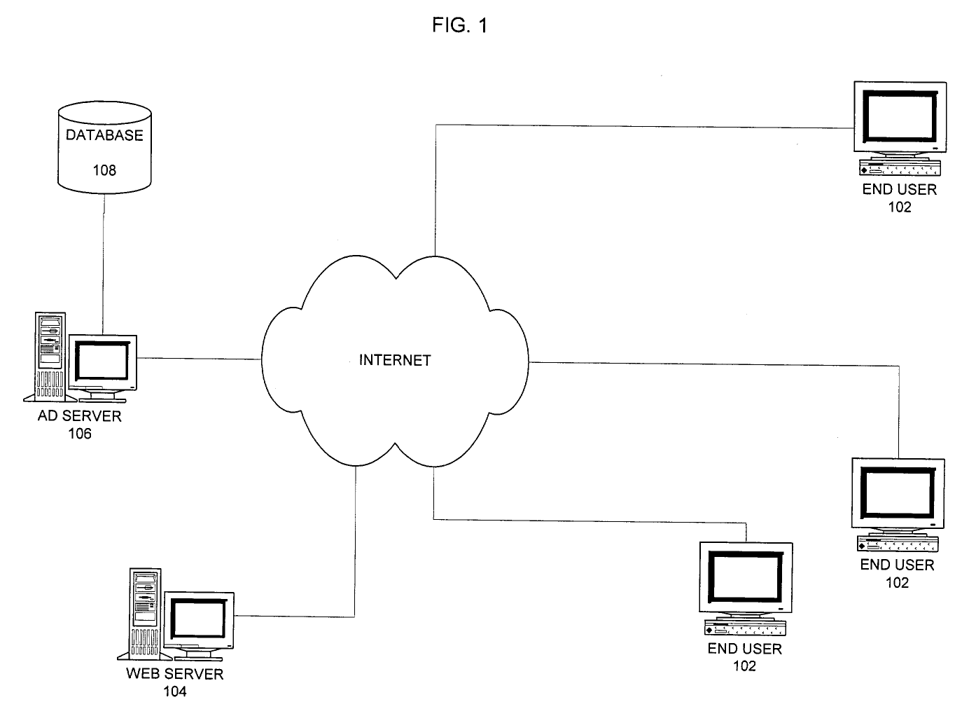

### DETAILED DESCRIPTION OF EXEMPLARY EMBODIMENTS

In general, the present invention relates to advertisements that may be provided or served via a network, such as the Internet, and whose content may dynamically change. More specifically, the advertisement, which may be written in any of a number of computer languages, such as Macromedia Flash, Java Script and the like, dynamically changes content based upon the date at which the advertisement is viewed. As used herein, the term date includes year, month, day, hour, second, millisecond and the like. As such, a difference in date may reflect a different year, month, day, hour, second, millisecond or the like; by way of further example, a different date may refer to a different hour of the same day or of different days and the same date may refer to the same hour of the same day or of different days. The date may be the current date of the end user's computer on which the advertisement is displayed or some other date available to the advertisement, such as via United States Naval Observatory (USNO) Network Time Protocol (NTP) or the atomic clock synchronization utility provided by the World Time Server (http://www.worldtimeserver.com). Either may also be used to check and correct the current date as read from the end user's computer. In certain embodiments, the content of the advertisement is based further on other factors, such as cookie data residing on the end user's computer.

As will be appreciated by those skilled in the art, the dynamic advertisement of the present invention provides several benefits over the prior art. For example, because the content dynamically changes, the provider of the advertisement need only upload the single advertisement rather than repeatedly uploading multiple static advertisements that collectively have the same content as the single dynamic advertisement. Consequently, the single dynamic advertisement saves not only technician time, but also costly electronic storage (memory) space. Moreover, it is anticipated that the dynamically changing advertisement will be more effective than static advertisements, as its message may be targeted based upon, among other things, date.

Certain preferred embodiments of the present invention will now be discussed with reference to the aforementioned figures, wherein like reference numerals refer to like components. In general, the system of the present embodiment includes end user processors 102, web server 104 and advertisement server 106 having a database 108, all of which are coupled to the Internet. The end user processors 102 include a scriptable browser, such as Internet Explorer, Netscape Navigator, Mozilla or Opera. The web server 104, provides web pages which are accessible by the end user processors 102. One of the web pages includes reference to the dynamic advertisement of the present embodiment. Such an advertisement, which is preferably written in Macromedia Flash and uses actionscript functions and methods, is served by advertisement server 106, as is generally known in the art.

It is to be understood that the present invention may be implemented utilizing any number of computer technologies. For example, although the present embodiments relate to providing access to content via the Internet, the present invention may be utilized over any computer network, including, for example, a wide area network. Similarly, the end user processors 102 may be any device that may be coupled to the network, including, for example, personal digital assistants, web-enabled cellular telephones, hard-wired telephones that dial into the network, mobile computers, personal computers, Internet appliances and the like. Furthermore, the servers described herein may be of any type, running any software, and the software modules, objects or plug-ins may be written in any programming language.

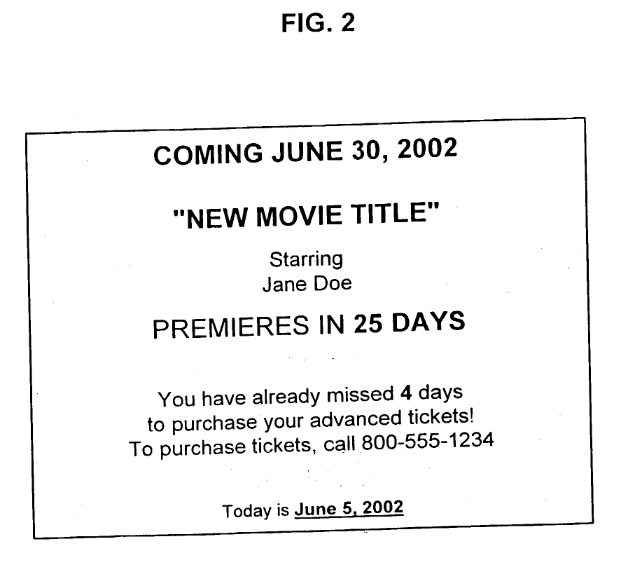

One exemplary advertisement is shown in the schematic of FIG. 2, which relates generally to the launch of a movie. As illustrated, the advertisement may display not only the current date (i.e., the date on which an end user views the advertisement), but also the number of days and/or hours until the launch date of the movie. Additionally, the advertisement also displays the time elapsed from some initial date, such as the start of the advertising campaign. As will be understood by those skilled in the art, displaying the time elapsed from the beginning of an advertising campaign (such as in conjunction with the counting down of time to the end of a sales campaign) may be used to further generate a sense of urgency, thereby encouraging a purchase or other action by the end user. Furthermore, in alternate embodiments, only use of the current date, elapsed time or any other information based therein may be displayed.

As described in greater detail below, the content of the advertisement dynamically changes based on the current date. Specifically, the advertisement counts down the number of days until the premiere until one day before the premiere, at which time the count down changes to hours until the premiere. Similarly, the number of days missed for purchasing advanced tickets (in the present embodiment, the number of days since the advertisement began to run) is also counted and displayed.

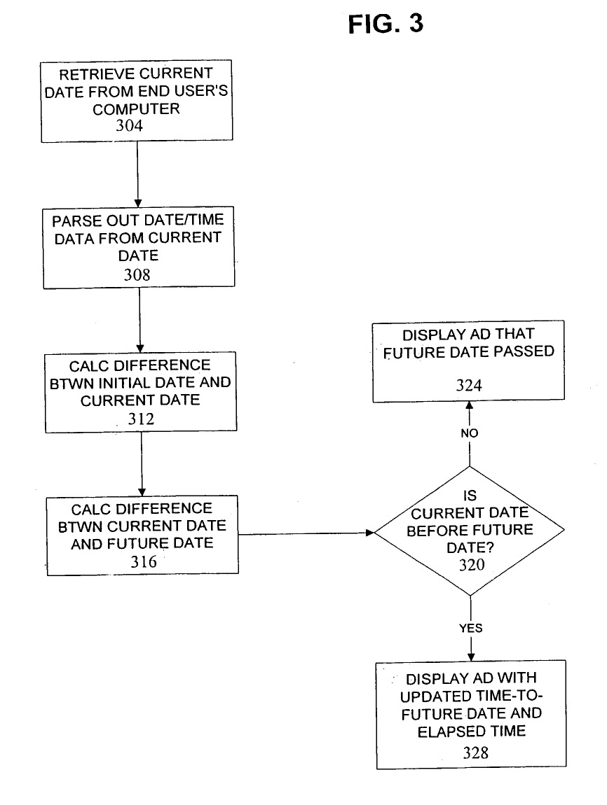

Having described the basic display of the advertisement, operation of the Flash software program used to create the advertisement will now be described in greater detail with reference to FIG. 3. Once the advertisement is served and the Flash program begins to execute, the program retrieves the current date from the internal clock of the end user's computer. Step 304. In the present embodiment, the actionscript of the program uses the “getDate( )” method to retrieve the Global Date Object from the end user's computer. As is known in the art, the Global Date Object specifies the year, month, day, hour, minute, second and millisecond of the internal clock of the computer. In alternate embodiments, the program retrieves the current date from another source, for example by making a call via the USNO NTP.

Once the current date is retrieved, the program parses out the date and time data from the current date. Step 308. It should be understood that the degree to which the date and time data is parsed from the current date depends upon the particular advertisement and the desired level of resolution (e.g., day, hour, second etc.). In the present embodiment, the advertisement is running in the same month as the launch date, and both the day and hours are parsed.

Having parsed out the date and time data, the program proceeds to calculate the difference between the start date of the advertising campaign (or, in other embodiments, some other initial date) and the retrieved current date, although not required. Step 312. In the present embodiment, the difference between the initial date and the current date is determined by subtracting the day of the initial date from the day of the current date.

In the event the initial date is during a preceding month, then the difference would be calculated in the following multi-step process: each month would have its total number of days predefined; the difference between the initial date and the predefined number of days in the preceding month would be calculated; and that difference would be added to the number of days that have passed in the then current month and the predefined number of days in all months in between.

The program also calculates the difference between the current date and the launch date of the movie (or some other future date in other embodiments). Step 316. Having calculated the difference between the current date and future date, the program next determines whether the current date is before the future date. Step 320. In the event the current date is after the future date, then the program causes the advertisement to be displayed including content (e.g., text, graphics, audio, animation and the like) indicating that the future date has past. Step 324. In certain embodiments where the advertisement is not run after the future date, steps 320 and 324 are omitted.

If the current date is before the future date, and the program causes the content of the advertisement to dynamically change to reflect the then current time-to-future date. Step 328. Because the program continuously runs in a loop, repeatedly determining the then current date and, based thereon, the then current time-to-future date, the advertisement functions to display a countdown to the future date.

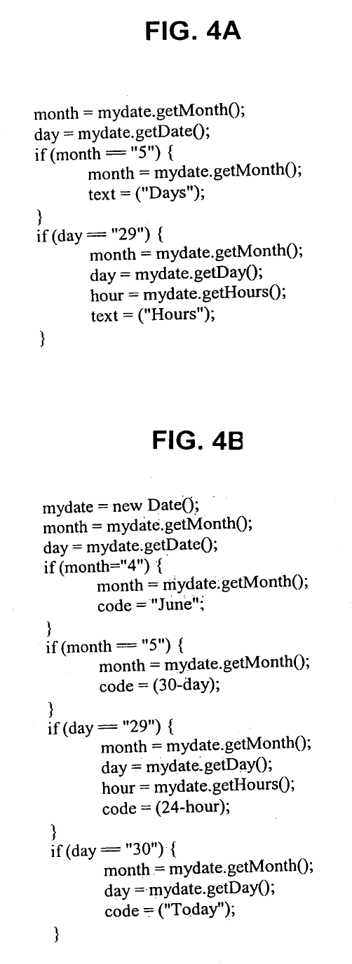

Having described the overall operation of the advertisement program, certain aspects of the program will now be described in greater detail with reference to FIGS. 4a and 4b. In the examples of FIGS. 4a and 4b, the launch date is June 30 of the current year, and the advertisement is run during the month of June.

In the present embodiment, the advertisement displays the countdown in number of days, until the time-to-future date is less than one day, at which time the countdown is displayed in hours. The code illustrated in FIG. 3a is one exemplary way to determine the transition of days to hours.

As illustrated in FIG. 4a, if the month of the current date is June, as represented by a “5” in the global date object (January being month “0”), then the text displayed in the advertisement is “days”, as the countdown is in days-to-launch. However, if the day of the current date is the 29th (i.e., representing a current date within one day of the launch date), then the text equals “hours”, and the countdown to be displayed is hours until the launch date. As such, in the present example, the text to be displayed in the advertisement is “Premieres in” followed by either “days” or “hours”.

As illustrated in FIG. 4b, for a month earlier than June, such as May (as represented by a “4” in the date object), the advertisement displays the phrase “Premieres in June,” with the text of “June” being dynamically added.

In the event the month of the current date equals June (as represented by a “5”), then the advertisement would display the number of the days until the launch, namely “30” minus the current day of the current date. As such, the advertisement would display the phrase “Premieres in X days”, where X represents the difference between the launch date of 30 and the then current day.

If the day of the current date equals 29, namely within one day of the June 30 launch date, then the advertisement would display the number of hours remaining to the launch, namely 24 minus the hour of the then current date. Finally, in some embodiments, if the day of the current date equals 30, then the advertisement would display the word “today.” In order to remove the static content “Premieres in”, a new frame would preferably be called.

Although the foregoing embodiment illustrated a dynamically changing advertisement in which the text of the advertisement changed, it is within the scope of the present invention to provide for dynamically changing advertisements where other components of the advertisements, for example, artwork, graphics, animation, audio and the like, can change. For example, in certain embodiments the advertising program uses the “goto frame” command to specify one of multiple potential frames to be displayed. In such an embodiment, the different frames may be displayed based upon essentially any categorization of date. For example, different advertisements may be displayed during different seasons (e.g., a different frame corresponding to different months), days (e.g., one frame being displayed during weekdays, with a different frame being displayed on weekends; one frame being displayed at the beginning of a month and another frame being displayed at the end of the month; or multiple frames being displayed on a round robin or random basis, each on a different day), different hours in a day (e.g., one frame being displayed during the morning hours, such as hours 0-11; another frame(s) being displayed during lunchtime, such as hours 11-14; and another frame(s) being displayed thereafter), and the like. In certain other embodiments, the contents of the advertisement are dynamically changed using the “load movie” command on a similar basis loading one or more of multiple movies based on any of the foregoing categorizations of date.

As noted above, the content of the advertisement may be dynamically changed based on factors in addition to (i.e., alone or in combination with) the current date. For example, the advertisement may include additional code to extract data from a cookie on the end user's computer. This information may be used as another variable in determining which version of the advertisement should be displayed to the end user. In general, any information contained in a cookie could be used as a factor in determining the advertising content, including other sites visited by the end user, the number of times the end user has visited a particular web site or web page, demographics of the user and the like. By way of example, a user logs into a website by providing a username and password. That usemame and password is associated with the user's profile which includes various demographics such as age, gender, address, hobbies, likes, dislikes, or any other information deemed relevant to the website provider or advertisers. Such demographic information, or a subset thereof, is stored in a cookie on the user's computer and can be accessed by the advertisement. In alternate embodiments, the cookie stores information identifying the user and the demographics for such user at a remote site such as a database server. Different advertisement content is associated with different demographics, thereby allowing the advertisement to dynamically change so that it is tailored to be effective to each user viewing it. In short, any information that can be reflected in a cookie can be extracted from the advertisement and used in the determination of what content to dynamically display to the end user.

For example, in one such embodiment, the advertisement or web page on which the advertisement runs may be programmed to place a cookie on the end user's computer each time the end user views the advertisement. The advertisement program, in turn, would also include code that, based on the existence or absence of the cookie, determine whether or not the user is viewing the advertisement for the first time. Based upon the cookie information, as well as the current date, the advertisement with different, dynamically generated content is presented. In one such embodiment, various items of content could be used (e.g., equally) for a period of time, while the (same or separate) system evaluates the effectiveness of each item of content. Once the current date equals a specified date, which thereby indicates the end of the evaluation period the advertisement calls a predetermined web site which specifies which item of advertisement content to use thereafter, either on a permanent basis or at particular times also as specified. The evaluation system advertisement criteria may be any of those known or hereafter known in the art, including for example, systems measuring click-throughs, customer acquisitions or other measures of effectiveness. In other of such embodiments, the evaluation period is determined based on achieving a number of users viewing the advertisement. Thus, the present invention allows for dynamic evaluation and modification of advertisements.

In yet another embodiment, the data that is used in connection with the changing of the advertisement may include information retrieved from a cookie regarding which websites the user has recently visited. For example an advertisement may be changed to include content regarding a certain product if data on the user's computer shows that the user has visited websites which specialize in a certain product.

In another embodiment, the data that is used in connection with the changing of the advertisement may include data that is in the user's calendar or to do list. For example the advertisement may be altered to include content regarding birthday gifts if the data on a user's computer indicates that a birthday is approaching. Alternatively the advertisement may include information about a certain product if data that is retrieved from the end-user's computer indicates that the user might need a certain product.

In yet another embodiment data about the user's computer itself may be retrieved and an advertisement may be altered based upon that data. For example if a user is running a certain type of processor or other peripheral hardware, such as a printer or monitor, an advertisement's content might be altered to include content regarding a possible upgrade for that hardware or other compatible products that are available.

In yet another embodiment, content within an advertisement can be changed to alert the user that an expiration date is approaching. For example if a user is participating in an on-line auction or other time specific activity, content may be changed within an advertisement to alert the user that there is only a certain amount of time remaining till the end of the allotted time.

It is also to be understood that the advertisement content may be altered or based upon comparison of two or more items of data such as date and cookie information. Furthermore, the content may be altered based upon comparison of one or more items of data, none of which are predetermined, for example, based solely on whether the user has viewed the advertisement previously. Furthermore, while exemplary embodiments have been described in which the difference between two items of data is used to alter or determine the content, the data could be applied to any type of algorithm or equation using such data (e.g., in which certain content is served based on time of day such as breakfast time, lunch time, and dinner time). As such, the term difference should be understood to encompass any algorithm or equation using the referenced data, including, but not limited to, mathematical difference between dates or other values.

Those skilled in the art will recognize that the method and system of the present invention has many applications, may be implemented in many manners and, as such, is not to be limited by the foregoing exemplary embodiments and examples. Moreover, the scope of the present invention covers conventionally known and future developed variations and modifications to the system components described herein, as would be understood by those skilled in the art.

1. A method of providing an advertisement that dynamically changes with reference to first data, the method comprising:
identifying second data;
determining a difference between the first data and the second data;
automatically altering the advertisement based upon the difference.

2. The method of claim 1 wherein the first data is a date and the second data is a current date.

3. The method of claim 2 wherein the first date is a future date.

4. The method of claim 2 wherein the first date is a past date.

5. The method of claim 2 wherein the current date is retrieved from a user's computer.

6. The method of claim 1 wherein the current date is retrieved from a remote site.

7. The method of claim 1 wherein the first data is stored in a cookie on the user's computer.

8. The method of claim 1 wherein the first data is information about websites a user has visited.

9. The method of claim 1 wherein the first data represents effectiveness of the advertisement having first content and the second data represents effectiveness of the advertisement having second content, and wherein the automatically altering includes altering the advertisement to include the more effective content of the first and second content.

10. The method of claim 1 wherein the advertisement is served from a server.

11. The method of claim 1 wherein the identifying, determining and altering are repeated each time the advertisement is served.

12. The method of claim 1 wherein the automatically altering includes using a goto frame command.

13. The method of claim 1 wherein automatically altering includes using a load movie command.

14. The method of claim 1 wherein the first data is information about the user's computer.

15. A system for providing an advertisement having content that dynamically changes with reference to first data, the advertisement, served to a user's computer, the system comprising:
one or more servers capable of serving an advertisement to the user's computer, the advertisement having changing content and containing computer code configured to:
identify second data;
determine a difference between the first data and the second data;
automatically determine the content of the advertisement based upon the difference.

16. The system of claim 15 wherein the first data is a date and the second data is a current date.

17. The system of claim 16 wherein the first date is a future date.

18. The system of claim 16 wherein the first date is a past date.

19. The system of claim 16 wherein the current date is retrieved from a user's computer.

20. The system of claim 15 wherein the second data is retrieved from a remote site.

21. The system of claim 15 wherein the first data is stored in a cookie on the user's computer.

22. The system of claim 21 wherein the first data is information about websites a user has visited.

23. The method of claim 15 wherein the first data represents effectiveness of the advertisement having first content and the second data represents effectiveness of the advertisement having second content, and wherein the automatically altering includes altering the advertisement to include the more effective content of the first and second content.

24. The system of claim 15 wherein automatically altering includes using a goto frame command.

25. The system of claim 15 wherein automatically altering includes using a load movie command.

26. The system of claim 15 wherein the first data is information about the user's computer.

27. A method of providing an advertisement having content that dynamically changes with reference to first data, the first data having multiple possible values, the method comprising:
associating a first content with a first value for the first data;
associating a second content with a second value for the first data automatically initiating display of the advertisement with the first content when the first data has the first value; and
automatically initiating display of the advertisement with the second content when the first data has the second value.

28. The method of claim 27 wherein the first data is a date and the first and the second values for the first data are then current dates.

29. The method of claim 27 wherein the first data represents a number of times the advertisement has been viewed.

30. The method of claim 27 wherein the first data represents a date.

31. The method of claim 27 wherein the first data represents information retrieved from a user's computer.

32. The method of claim 27 wherein the first data is retrieved from a remote site.

33. The method of claim 27 wherein the first data represents information stored in a cookie.

34. The method of claim 33 wherein the first data represents information about websites a user has visited.

35. The method of claim 27 wherein the first value represents a first set of user demographics and the second value represents a second set of user demographics, the first content tailored to users having the first set of user demographics and the second content tailored to users having the second set of user demographics thereby dynamically providing the advertisements with content tailored to users.

36. The method of claim 27 wherein the advertisement is served from a server.

37. The method of claim 27 wherein the identifying, determining and altering are repeated each time the advertisement is served.

38. The method of claim 27 wherein automatically displaying includes using a goto frame command.

39. The method of claim 27 wherein automatically displaying includes using a load movie command.

40. The method of claim 27 wherein the first data is information about the user's computer.

41. A system for displaying an advertisement that dynamically changes with reference to a first data, the system comprising:
a server for serving the advertisement;
a computer capable of downloading the advertisement from the server, the advertisement having changing content and containing computer code that can:
identify second data;
calculate a difference between the first data and the second data; and
automatically initiate display of the advertisement having content based upon the calculation.

42. The system of claim 41 wherein the first data is a date and the second data is a current date.

43. The system of claim 42 wherein the first date is a future date.

44. The system of claim 42 wherein the first date is a past date.

45. The system of claim 42 wherein the current date is retrieved from a user's computer.

46. The system of claim 42 wherein the current date is retrieved from a remote site.

47. The system of claim 41 wherein the second data is stored in a cookie on the user's computer.

48. The method of claim 47 wherein the first data is information about websites a user has visited.

49. The method of claim 41 wherein the first data represents effectiveness of the advertisement having first content and the second data represents effectiveness of the advertisement having second content, and wherein the automatically altering includes altering the advertisement to include the more effective content of the first and second content.

50. The method of claim 41 wherein automatically altering includes using a goto frame command.

51. The method of claim 41 wherein automatically altering includes using a load movie command.

52. The method of claim 41 wherein the first data is information about the user's computer.

53. A method of serving an advertisement that dynamically changes with reference to first data and second data, the method comprising:
serving the advertisement at a first date when the advertisement contains first content; and
serving the advertisement at a second date when the advertisement contains second content, the second content being different from the first content and being based on a difference between the first data and the second data.

54. The method of claim 53 wherein the second data has a first value at the first date and the second data has a second value at the second date.

55. The method of claim 54, wherein the second content is different from the first content based on a difference between the first value and the second value.

56. The method of claim 54 wherein the first data represents a predetermined date and the second data represents a current date.

57. A method of serving a dynamically changing advertisement, the method comprising:
identifying first data, the first data having multiple possible values;
automatically serving the advertisement with a first content when the first data has a first value; and
automatically serving the advertisement with a second content when the first data has a second value, the first content different from the second content.

58. The method of claim 57 wherein the advertisement further changes based on a second data, the method further comprising:
automatically serving the advertisement with the first content based on the second data and the first value; and
automatically serving the advertisement with the second content based on the second data and the second value.

59. The method of claim 58 wherein automatically serving the advertisement with the first content is based on a difference between the second data and the first value.

60. A computer readable medium comprising computer code for providing an advertisement that dynamically changes with reference to a first data, the computer code to configure one or more processors to:
identify a second data;
determine a difference between the first data and a second data and;
alter the advertisement based upon the difference.

61. The computer readable medium of claim 60 wherein the first data is a date and the second data is a current date.

62. The computer readable medium of claim 61 wherein the first date is a future date.

63. The computer readable medium of claim 61 wherein the first date is a past date.

64. The computer readable medium of claim 61 wherein the first date is retrieved from a user's computer.

65. The computer readable medium of claim 61 wherein the first date is retrieved from a remote site.

66. The computer readable medium, of claim 60 wherein the first data is stored in a cookie on the user's computer.

67. The computer readable medium of claim 66 wherein the first data is information about websites a user has visited.

68. The method of claim 60 wherein the first data represents effectiveness of the advertisement having first content and the second data represents effectiveness of the advertisement having second content, and wherein the automatically altering includes altering the advertisement to include the more effective content of the first and second content.

69. The computer readable medium of claim 60 wherein automatically altering includes using a goto frame command.

70. The computer readable medium of claim 60 wherein automatically altering includes using a load movie command.

71. The computer readable medium of claim 60 wherein the first data is information about the user's computer.
